(19) United States
(12) Patent Application Publication
(10) Pub. No.: US 2007/0204043 A1
(43) Pub. Date: Aug. 30, 2007

(54) Method, system and apparatus for rejecting unauthorized or SPAM e-mail messages.

(76) Inventors: Claudia Leticia Espinosa, Tampa, FL (US); Jose Trinidad Barriga, Tampa, FL (US)

Correspondence Address: CLAUDIA L. ESPINOSA, 9205 PEBBLE CREEK DRIVE, TAMPA, FL, 33647, US

(21) Appl. No.: 11/695,046

(22) Filed: Apr. 1, 2007

Related U.S. Application Data
(63) Continuation-in-part of application No. 10/859,669, filed on Jun. 3, 2004.
(60) Provisional application No. 60/476,938, filed on Jun. 9, 2003.

(51) Int. Cl. G06F 15/173

(52) U.S. Cl. 709/225

(57) ABSTRACT

A new method, system and apparatus of rejecting junk mail by using an access code that the sender inserts anywhere in the “SUBJECT” or “MESSAGE” sections of the e-mail message, and only those e-mail messages containing a valid access code either previously defined by the owner of the e-mail or dynamically generated for a particular e-mail address are delivered. Successful senders are then added in a list of approved senders, so they do not need to add the access code in future messages. The messages without a valid access code are returned to the sender with instructions to include the access code either in the SUBJECT or MESSAGE sections of the e-mail. If the access code is not known, the instructions request the sender to access an Internet page to respond to personal questions about the e-mail owner. Only those senders that can answer to at least one of these questions correctly obtain the access code. Alternative instructions are offered in the message returned to the sender to access a dynamically generated Internet contact-me form with the FROM, TO, SUBJECT and MESSAGE fields optionally pre-populated with the information of the original e-mail and optionally editable. After the sender submits the form, an e-mail is generated with this information and delivered to the recipient.

### CROSS-REFERENCE TO RELATED APPLICATIONS

This application is a Continuation-in-Part of U.S. utility patent application Ser. No. 10/859,669 filed Jun. 3, 2004 entitled “Method, system and apparatus for rejecting unauthorized or SPAM e-mail messages”, which in turn is a non-provisional application of U.S. provisional application Ser. No. 60/476,938 filed Jun. 9, 2003 which are hereby incorporated by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### TECHNICAL FIELD OF THE INVENTION

The present invention relates to electronic mail, and more specifically, to methods, systems and apparatus that identify and reject spam.

### BACKGROUND OF THE INVENTION

Please note that the terms mail, e-mail, email and message are used indistinctly in this document, and they all mean and indicate an electronic mail message. Also MESSAGE in uppercases indicates the body section of an e-mail message, recipient or e-mail owner means the e-mail account and computer servers that use this invention, and sender means anybody sending e-mail messages to the recipient that use this invention.

Traditionally, bulk e-mail distributors and solicitors collect or buy lists of e-mail accounts from other individuals that are obtained mainly without permission or knowledge of the owner to send unsolicited and unwanted advertisement everyday, and it is often major the number of spam than the legitimate mail received.

Other common technique used by advertisers to send unsolicited e-mail is to create programs that generate sequential names for well-known big e-mail providers and expect for valid hits after the millions of generated e-mail accounts. For example: they would create a program to send mail to aaa@domain.com, aab@domain.com, aac@domain.com, and so on, creating millions of combinations and selecting then the valid accounts not rejected to compile lists and send more advertisement.

The frustration increases when the final user does not seem to have an easy way to stop bulk companies from eventually knowing their e-mails addresses. Some advertisers add a link at the bottom, or a Reply-with-remove mechanisms to have an specific e-mail account deleted from their mailing lists, but this usually creates a bigger problem because when advertisers receive a mail back, they know that the account is active and someone read the message, so they just keep using and selling the account to others with added value.

This entire problem has been growing uncontrolled and makes it difficult for the owner to select the legitimate mail from spam, and leaves a feeling of impotence, anger and frustration. An additional concern for parents is that many of the e-mail holders are children, and a big number of the spam mail has sexual content, links to pornography sites, scams, frauds, and computer virus. In addition, current laws and legislation has proven to be non-effective in controlling the problem especially for spammers in foreign countries without regulating or enforceable laws.

Many users have been changing their e-mail accounts from time to time after they receive too much spam, but this has a downside. Changing accounts often cause that friends, family or business contacts may not receive the new address, and therefore may lose contact with them. In the best of the cases, the persons who want to contact the owner again needs an alternate method to contact the owner to obtain the latest e-mail account and then update their book addresses for each one.

Other method that some people implement to avoid spammers is to open several accounts for specific uses. For example “shopping” e-mails used where it is more common to have the e-mail stolen, and just check it for new mail when there is a shopping in progress that needs to be tracked. With that method, the owner needs to keep several accounts and passwords, which implies additional log in, cleaning and revision times.

Other frequently used method is the development of e-mail filters (see U.S. Pat. No. 6,732,157) that scan the subject and message of incoming mails for specific words. Based on its match/no match result, the message is sent to an additional in-box, so the owner can review it later in case that some mail was not separated correctly. That method has some problems as well because there is always the risk of discarding a legitimate mail. An additional problem is that advertisers are using every time more common, diverse and friendly language that may be interpreted by filters as non-commercial e-mail and delivered in the “clean” in-box. A downside of that method and other similar is that the user requires extra time to review in-doubt boxes.

So far these and some other methods have not been able to effectively control unsolicited mail and have only reduced the problem at least in the non-commercial or corporative fields, leaving free or public-known providers dealing with a big problem and frustration for their customers.

### BRIEF SUMMARY OF THE INVENTION

The object of the invention is to create a service, a method, computer code and apparatus that rejects junk mail and accepts legitimate mail by using an access code that the sender (FIG. 1.1) have to insert in the “SUBJECT” or “MESSAGE” sections of the e-mail message (FIG. 1.3), and only those messages containing this access code are delivered to the recipient (FIG. 1.9). Once a sender has successfully sent a message with the access code, his/her e-mail is added to an approved list of senders and the access code is not needed for future messages from the same sender. The messages without the mentioned access code or from unapproved senders (FIG. 3.2) can also be saved in a temporal location in the mail server for a limited period of time (FIG. 3.3), and if the sender is manually or automatically approved later (FIG. 3.6 and (FIG. 3.7)), this saved message or messages can be automatically delivered to the inbox of the e-mail owner (FIG. 3.8).

The improvement of this method is the way to obtain the mentioned access code. When an e-mail is sent to the e-mail owner without the access code (FIG. 1.3), the message is not delivered to the inbox but returned to the sender with instructions to access an Internet page (FIG. 1.5) that lets the sender obtain the code only if he/she knows personal key information of the owner (FIG. 1.8) like the first or last name, city where the person lives, zip code, hobby, pet name, etc. Furthermore, the access code can be either the one previously defined by the recipient for use with any sender's e-mail, or it can be dynamically generated access code tied to a particular sender, so it cannot be used with any other e-mail than the one used originally to contact the recipient.

When the e-mail owner (FIG. 4.1) sends e-mail messages to recipients that are not in his/her approved list of senders (FIG. 4.2), the e-mail addresses and names of the recipients can be automatically added to the approved list of senders (FIG. 4.3, 4.4 and 4.5). In this way, if any of these recipients write back to the e-mail owner (FIG. 4.6), their messages will be accepted since he/she was approved before (FIG. 4.8).

Other improvement of this invention is that if the source e-mail is fictitious (invented or deleted after the message is sent) or it was sent by a solicitor or mass e-mail spam sender, the sender either does not receive the reply requesting the access code (FIG. 2.4), or he/she will not be able to guess it, and he/she will not sent back the message to the recipient. The recipient will never even know that an unsolicited spam message was sent to his/her e-mail inbox (FIG. 2.5), liberating him/her of the extra time and effort of reading and classifying these messages or checking extra in-doubt mailboxes or e-mail folders typical of inefficient spam filters. By using this invention, the effort to approve a new sender is passed precisely to the sender and not to the recipient making spammers hard to reach the recipient while the desired contacts will not have major problems to approve themselves.

Another important improvement of this idea is that the web server, e-mail server and/or the anti-spam system do not necessarily need to be in the same server or the same location. The web, e-mail and anti-spam servers can be in remote locations and communicate using tools like XML to send the SUBJECT, MESSAGE, FROM, TO and BCC sections of the e-mail message among them, as well as the decision to accept or reject a message. This is also true for e-mail client programs like Outlook or Eudora communicating to a remote e-mail server and a local or remote anti-spam server or system.

One more improvement is that if the previously explained method, system and apparatus fails or is inappropriate for any reason, (for example if the recipient does not have any personal questions defined), alternative instructions can be offered in the message returned to the sender (FIG. 5.5) to access a dynamically generated Internet contact-me form with the FROM, TO, SUBJECT and MESSAGE fields optionally pre-populated with the information of the original e-mail and optionally editable (FIG. 5.6). After the sender submits the form, an e-mail is generated with this information and delivered to the recipient (FIG. 5.7), and the sender e-mail can be either automatically added to the approved list of e-mail addresses, or it can be manually added to the approved list of senders by the e-mail owner (FIG. 5.9).

### BRIEF DESCRIPTION OF THE SEVERAL VIEWS OF THE DRAWING

FIG. 1 shows the order of actions when a sender(1) with a real e-mail sends an e-mail message to a recipient(9), and when the sender is not in the approved list of senders(9) or the e-mail message is sent without an access code or with an invalid access code, the sender(1) receives the e-mail message back with instructions to insert or obtain the access code(4, 5, 6, 7, 8).

FIG. 2 shows the order of actions when a sender(1) with an invented, fictitious or deleted e-mail(4) sends a message to the recipient without the access code or with an invalid access code(3). The sender does not receive back the instructions to obtain the access code and the original e-mail and any errors about the same e-mail are ignored(5, 2) and the recipient(6) never knows that he had this e-mail sent to his mailbox.

FIG. 3 shows the order of actions when a sender(1) with a real e-mail sends an e-mail message to a recipient(8), and when the sender is not in the approved list of senders(9) or the e-mail message is sent without an access code or with an invalid access code, the message is saved in a temporary location for a limited period of time(3), and it is later delivered to the e-mail owner when the sender is automatically(6) or manually(7) approved later.

FIG. 4 shows the order of actions when an e-mail owner(1) send a message to a recipient(2) that has not been approved(3) and then it is automatically added(4) to the list of approved senders(4). If at a later time, the mentioned recipient replies to the message(7), the message will be accepted to the e-mail owner(7) since it has been previously approved(8).

FIG. 5 shows the order of actions when a sender(1) with a real e-mail sends an e-mail message to a recipient(9), and when the sender is not in the approved list of senders(3) or the e-mail message is sent without an access code or with an invalid access code, the sender(1) receives the e-mail message back(5) with instructions to access an Internet contact-me form(6) with the information of the original e-mail taken from a table or file where it was saved(4). This figure also shows that the form is disabled for a period of time after it is submitted(8).

### DETAILED DESCRIPTION OF THE INVENTION

The main problem is that advertisers and spam senders only need to know the e-mail address to send a message, so this invention creates a service, a method, computer code and apparatus to offer e-mail services to customers or users that when registering they need to enter as part of their regular information such as first name, last name, access password, address, etc, an additional e-mail access code. It is also suggested that the created e-mail address be a pseudonym that does not reveal any real information about the user. In other words, it should not contain full or sub strings parts of the first name, last name, address, profession, etc. The reason is explained in the next paragraphs.

The e-mail access code can be any word, nick name or number. It is suggested that it does not exist in dictionaries and contains some numbers or special characters, so it will be difficult to guess by spammers.

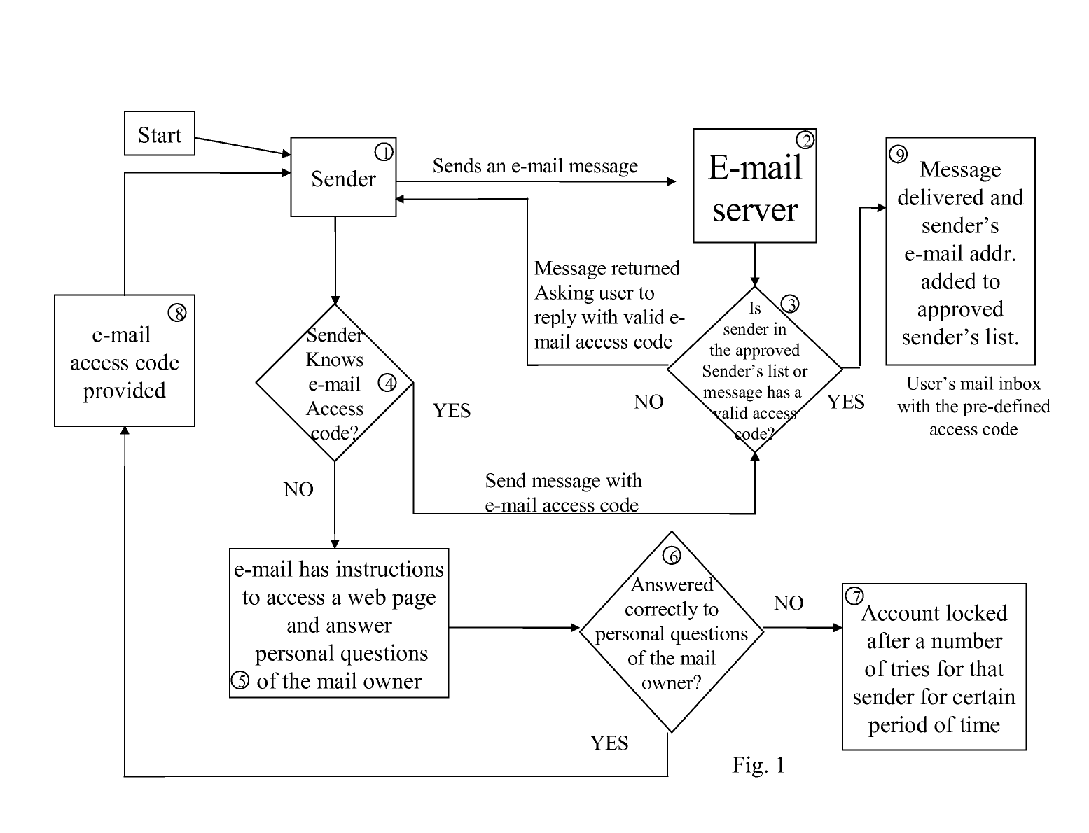

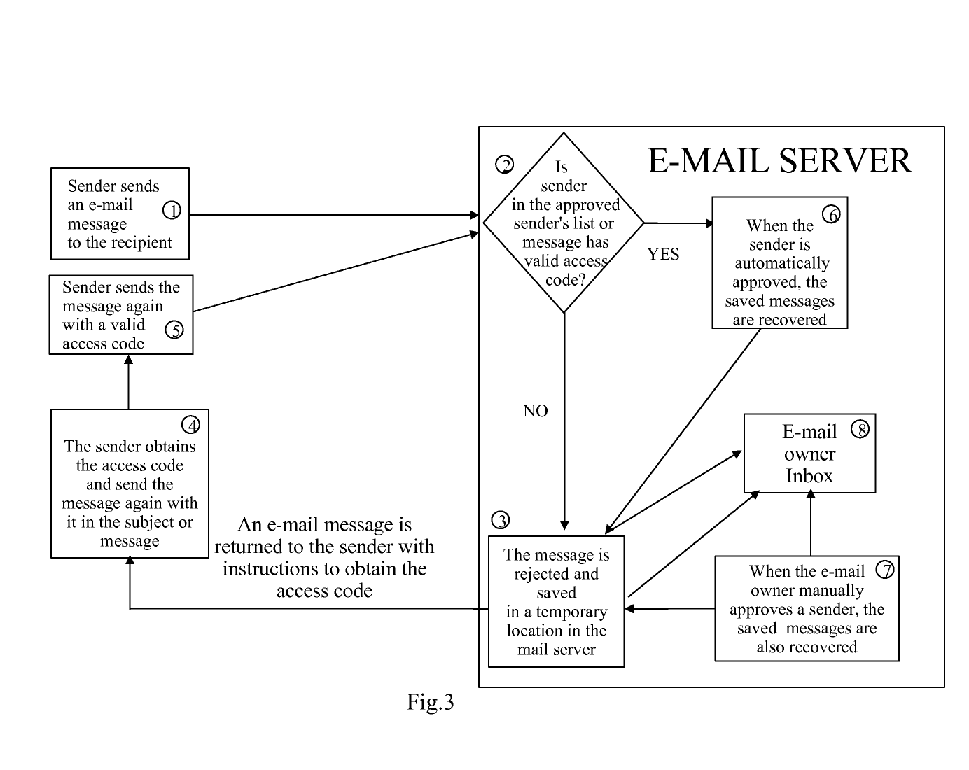

Once the account and the e-mail access code are created and an e-mail is received, if the sender is in the list of approved senders, the message is accepted for delivery to the recipient. On the contrary, if the sender is not in the approved list of senders, the SUBJECT and MESSAGE sections of the e-mail is reviewed for the a valid access code; if it is present either in the SUBJECT or anywhere in the MESSAGE, the e-mail is accepted and the sender is added to the approved list of senders, otherwise, the message is not be delivered, but returned to the sender with instructions in several languages, indicating that in order to deliver the message, the sender has to reply with an access code inserted either in the SUBJECT or MESSAGE fields (FIG. 1). The rejected messages not delivered to the recipient can be also saved in a temporal location in the mail server for a limited period of time, and if the sender is manually or automatically approved later, all his/her saved message or messages can be automatically delivered to the inbox of the e-mail owner (FIG. 3).

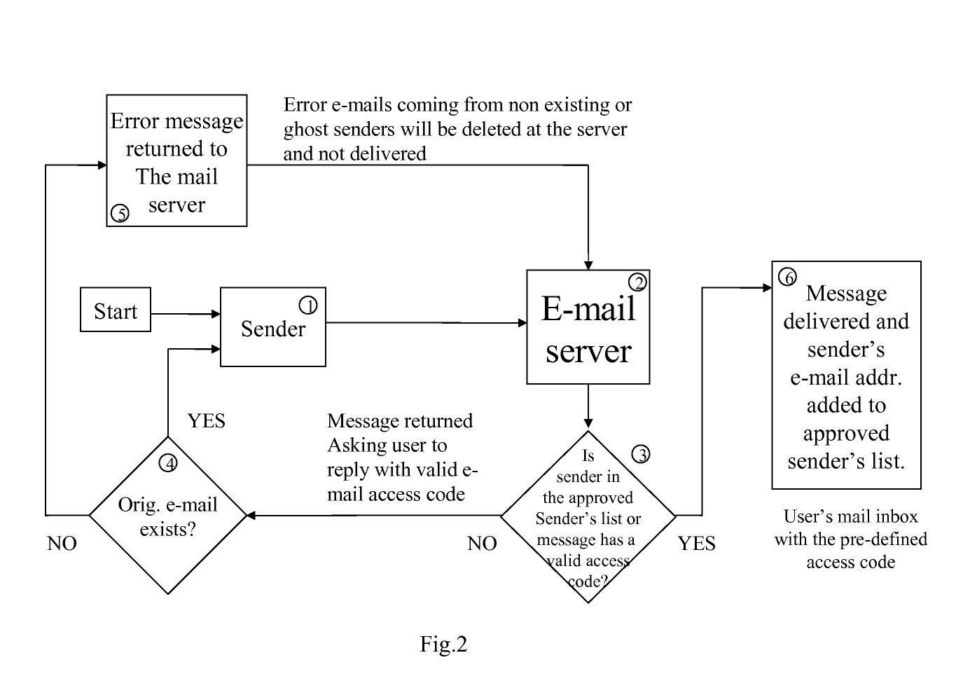

If the sender e-mail is a ghost or invented account, or the sender's e-mail was deleted after the original message was sent (common practice of spammers and solicitors), the reply message would not find the reply mailbox and these error messages are ignored all together (FIG. 2). When the sender's mailbox is real, the sender must read and follow the instructions in the reply message in order to make the message reach the recipient as described in the next paragraph.

The action required from the sender if the access code is known is to reply to the message and insert the access code either in the SUBJECT or MESSAGE sections, otherwise, the sender must follow the instructions in the same mail to obtain the access code by accessing a web page built dynamically for the specific e-mail owner. The sender then has to enter key personal information of the recipient to obtain the mentioned access code such as first name, last name, city where the person lives, school, zip code, hobby, etc (either one, not all). In this way, only those senders who really know the e-mail owner will know the correct answers, and can get the e-mail access code after answering correctly to at least one of the questions (the questions can have more than one correct answer). This access code can be either previously defined by the recipient for use with any sender's e-mail address, or it can be dynamically generated and tied to a particular sender's e-mail, so it cannot be used by any other e-mail than the one used originally to contact the recipient.

After obtaining the recipient's access code, the sender only has to reply to the rejected message (since it has the owners e-mail address in the From field) and add the e-mail access code either in the SUBJECT or MESSAGE sections, and the message will be delivered the second time (FIG. 1).

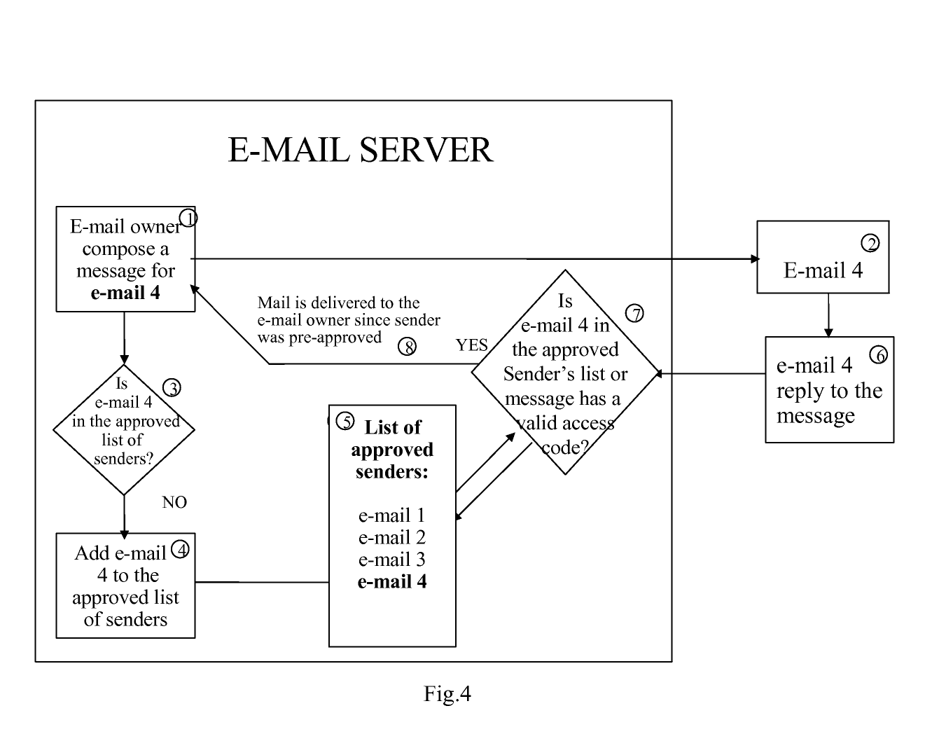

When the e-mail owner sends e-mail messages to recipients that are not in his/her approved list of senders, the e-mail addresses and names of the recipients can be automatically added to the approved list of senders. In this way, if any of these recipients write back to the e-mail owner, their messages will be accepted since he/she was approved before (FIG. 4).

When created, it is suggested that the e-mail account of the recipient be a pseudonym or do not contain revealing information about the owner's identity or information that will reveal the answer to the questions to obtain the access code. This does not represent a major problem since outside the corporative environment e-mail accounts are most of the time pseudonyms anyway. For situations where real names are needed as part of the e-mail account, especially in business, the e-mail access code can be name of a city, zip code, building location, profession, department, etc.

An additional protection mechanism at the server is to disable the screen to obtain e-mail access code for the specific accounts for several minutes or hours after a limited number of tries to obtain the e-mail access code unsuccessfully, so it can protect the access code for sequentially generated automated attacks with computers. Additional server protection can block specific IP addresses for recurring tries from the client, and encryption the fields of the mentioned screen which is standard when sending secure sensitive information thorough public networks. Finally, a CAPTCHA (Completely Automated Public Turing test to tell Computers and Humans Apart) image can be used to make sure that a person is answering to the questions and not a computer.

The e-mail owner also has access through web pages to statistics of persons trying to gain access to his/her e-mail access code, and eventually they are able to contact them if they unsuccessfully tried to obtain the e-mail access code but are wanted contacts. Those senders unable to obtain the access code have the option to leave their name and e-mail for further contact.

In the case of advertisers, solicitors or spammers ever steal the e-mail access code, and the e-mail owner starts receiving spam or junk mail, he/she only has to log in to his/her account with his/her user (usually the e-mail account) and the account password, and change the e-mail access code for a new one. New senders who know personal information about the e-mail owner can obtain the new e-mail access code again in just few minutes. As a logical conclusion, a user will never have to change his/her e-mail account. The same e-mail account can be used for life as long as the e-mail service provider is in business.

Additionally and even though not needed to make this invention works, this additional improvement increase the security and management of e-mail access codes, so when the e-mail owner wants to send mail from his account, an additional MIME field to the commonly found in e-mail applications (FROM, TO, CC, BCC, SUBJECT and MESSAGE or BODY) named “e-mail access code” can be created, and populated in all outgoing e-mail messages with the access code entered in this field is automatically added to the message when sending the e-mail. Eventually, if this invention becomes a standard in the industry, the field would be a completely separated field and encrypted for protection using methods like SSL or similar encryption tools and also sent to other mail servers as a separate field to be received and handled as such. It can also and eventually be added to Electronic Book Address applications as a new field.

Once a message with the valid access code has been delivered to the recipient, the sender's e-mail is added to an approved e-mail addresses list (this can function also as an address book), so those senders do not have to include the access code again when they send new messages. The e-mail owner have also the choice of deleting or adding e-mail addresses manually to this list of approved senders, and he/she has the option to add generic senders for a specific domains. For example, an entry like *@xycmail.com or xycmail.com will allow the owner to receive mail from sales@xycmail.com or custserv@xycmail.com.

An example of an access code could be ABXYZ12.
An example of the access code inserted in the SUBJECT field can be the following:
“Regards from your friends in Hawaii ABXYZ12”
An example of the access code inserted in the SUBJECT field is (can be anywhere in the message):
Hello John.
We hope you are fine. Say hello to your wife.
Regards
ABXYZ12
   To speed up the search, it is suggested that the access code is inserted at the beginning of the SUBJECT and/or at the top of the MESSAGE, but it can be placed anywhere.

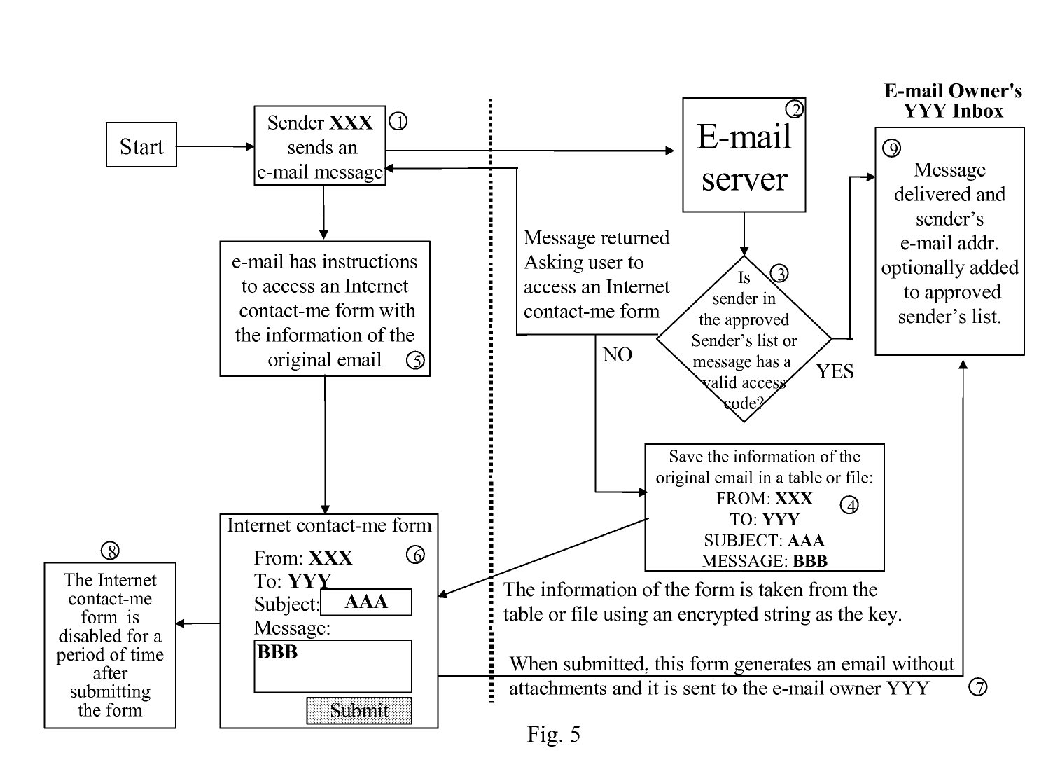

One more improvement is that if the previously explained method, system and apparatus fails or is inappropriate for any reason, for example if the recipient does not have any personal questions defined, or the sender fails to answer one of these questions correctly, an alternative method for the sender to contact the recipient is offered, by accessing a dynamically generated Internet contact-me form with the FROM, TO, SUBJECT and MESSAGE fields optionally pre-populated with the information of the original e-mail and optionally editable (FIG. 5.6). After the sender submit the form, an e-mail is generated with this information and delivered to the recipient, and the sender e-mail can be either automatically added to the approved list of e-mail addresses, or it can be requested to the to the recipient in the generated e-mail to manually approve the sender if desired. As an additional protection, this form can be disabled for a certain period of time for a particular e-mail or for a particular IP address after a message has been submitted (FIG. 5).

This additional method of contact from senders to recipients has also several advantages, since the sender cannot attach images or files with potential viruses or undesired images to this Internet form, and the FROM and TO fields can be made non editable, so the sender and recipient cannot be altered when using this form. The information that is pre-populated in this form can also be obtained from an encrypted variable that is part of the URL address either directly or as a key to a database with the sender-recipient information, to make sure that the FROM and/or TO fields are not tampered with by the sender. This method also works as a means to let senders contact e-mail owners in Internet pages, where the FROM, SUBJECT and MESSAGE sections can be filled, and the TO field is either non-editable or completely hidden to the sender to protect his/her e-mail address from spammers and from being changed (FIG. 5).

Finally, with this Method, system and apparatus for rejecting unauthorized or SPAM e-mail messages, the web server, e-mail server and/or the anti-spam system do not necessarily need to be in the same server or the same location. The web, e-mail and anti-spam servers can be in remote locations and communicate using tools like XML to send the SUBJECT, MESSAGE, FROM, TO and BCC sections of the e-mail message between them, as well as the decision to accept or reject a message. This is also true for e-mail client programs like Outlook or Eudora that communicate to a remote e-mail server and a local or remote anti-spam server or system.

In other patented methods I found in my research, the messages which do not have this e-mail access code are transferred to an in-doubt or alternate in-box to be reviewed by the user later on and decide if they are good or not. It requires additional time and effort from the user to select valid messages from spam and unsolicited advertisement.

The big improvement of this compared to current methods is that when a message is rejected, no further action is needed from the e-mail owner; it only requires action from the original sender. An additional benefit is that when the mail is sent from ghost users or not valid actual and existing e-mail accounts, the message requesting a reply with the e-mail access code is not be delivered to anyone, and nobody replies either to the message or try to find the e-mail access code, so it is completely transparent for the user and he/she never knows that junk mail was sent to his/her account. All error messages returned from the reply to ghost accounts are automatically eliminated as well, and they never reach the clean inbox.

Other improvement is that the e-mail owner has access to review only the e-mails and IP addresses of persons who tried to obtain his/her e-mail access code, and not all persons who unsuccessfully sent him/her mail, making the list to review very short, or shorter than with current filtering methods.

Other benefit for server owners and e-mail services providers is that since senders need to know personal information about the e-mail owner, it would be likely that persons opening new accounts will provide real and current data when registering, instead of fake or invented information.

One final advantage is that any regular currently existing application or new development can be used to send mail under this improved method because the e-mail access code is inserted either in the SUBJECT or MESSAGE fields, and those are currently found in any mail management system. The Owner of an e-mail is able to send mail to anybody he/she wants to in a regular way having also the option of adding the e-mail access code the outgoing e-mail. For existing e-mail or address-book applications with out a field specifically created to store the e-mail access codes, they can be stored together as part of a standard header or footer, so they are added when a new e-mail is created

What is claimed is:

1. The method, system and apparatus wherein after a rejected e-mail, the sender accesses the HTML web page indicated in the instructions (FIG. 1.5) and answers correctly to at least one of the questions defined by the e-mail owner (FIG. 1.6) and the access code is delivered in a subsequent screen (FIG. 1.8).

2. The method of claim 1, wherein the rejected messages are saved to a temporary location in the mail server for a limited period of time (FIG. 3.3).

3. The method of claim 2, wherein the saved messages are automatically delivered to the Inbox of the e-mail owner (FIG. 3.8) if the sender is manually or automatically approved later (FIG. 3.6 and 3.7).

4. The method of claim 1, wherein a question defined by the e-mail owner can have more than one correct answer. For example: Valid answers to the question “Places where I have lived?” can have as correct answers Cleveland, Tampa and Dallas, and they can be stored in a table or file using some character like a comma as a separator for each valid response i.e. Cleveland, Tampa, Dallas.

5. The method of claim 1, wherein a CAPTCHA (Completely Automated Public Turing test to tell Computers and Humans Apart) image is used to protect against automatic attacks and make sure that a person is answering to the questions and not a computer.

6. The method of claim 1, wherein the access code obtained by the sender after answering correctly to one of the questions can be a dynamically generated access code tied to a particular sender, so it can not be used by any other e-mail than the one used originally to contact the recipient. This dynamically generated access code is disabled after a determined period of time or after it is used the first time whichever occurs first.

7. The method of claim 1 wherein if the web server, e-mail server, email client and/or the anti-spam system method and apparatus can be in different networks, computers or servers in remote locations, and they can communicate among themselves using any tools and protocols to send the SUBJECT, MESSAGE, FROM, TO and BCC sections of the e-mail message as well as the access code and the decision to accept or reject a message.

8. The method, system and apparatus wherein the e-mail owner (FIG. 4.1) sends e-mail messages to recipients that are not in his/her approved list of senders (FIG. 4.2), and as a result the e-mail addresses and names of the recipients are automatically added to the approved list of senders (FIG. 4.3, 4.4 and 4.5). In this way, if any of these recipients write back to the e-mail owner (FIG. 4.6), their messages will be accepted since he/she has been previously approved (FIG. 4.7 and 4.8).

9. The method, system and apparatus wherein the mail server (FIG. 5.1 and 5.2) receives an incoming e-mail message for the e-mail owner (FIG. 5.9), and it does not find the e-mail address of the sender in the list of approved senders, and there is not a positive match between the access code either in the SUBJECT or MESSAGE sections of the e-mail and the owner's defined access code (FIG. 5.3), then the message is sent back to the sender with the explanation of why the message is not being delivered, and it requests the sender to access an dynamically generated Internet contact-me form (FIG. 5.5).

10. The method of claim 9, wherein a CAPTCHA (Completely Automated Public Turing test to tell Computers and Humans Apart) image is used to protect against automatic attacks and make sure that a person is answering to the questions and not a computer.

11. The method of claim 9, wherein the mentioned Internet contact-me form is dynamically generated with information of the original e-mail message sent from the sender to the recipient, having the FROM (the sender) and the TO (the recipient) fields pre-populated and non editable so that they cannot be altered when using this form, and the SUBJECT and MESSAGE fields pre-populated and editable (FIG. 5.4 and 5.6).

12. The method of claim 11, wherein the sender submit the mentioned Internet contact-me form, and an e-mail is generated with its information and delivered to the recipient (FIG. 5.7), and the sender e-mail is automatically added to the approved list of senders (FIG. 5.9).

13. The method of claim 11, wherein the sender submit the mentioned Internet contact-me form, and an e-mail is generated with its information and delivered to the recipient (FIG. 5.7), and the sender e-mail is not automatically added to the approved list of senders, but it is requested to the recipient as part of the message in the generated e-mail to manually approve the sender if desired (FIG. 5.9).

14. The method of claim 11, wherein the mentioned Internet contact-me form does not include any attachments from the original e-mail message, and it does not allow either any form of attachment or scripting code in the message section of the form to protect the recipient from any kind of attacks including viruses or undesired images. Only plain text is permitted in the message section of the form (FIG. 5.6).

15. The method of claim 11, wherein the information that is pre-populated in this form is obtained from an encrypted variable that is part of the URL address of the Internet contact-me form. This is done to make sure that the FROM and/or TO fields are not tampered with by the sender (FIG. 5.4 and 5.6).

16. The method of claim 11, wherein the information that is pre-populated in this form is obtained from a database or table where the FROM, TO, SUBJECT and MESSAGE information of the original e-mail message is stored, and which key is an encrypted variable part of the URL of the Internet contact-me form. This is done to make sure that the FROM and/or TO fields are not tampered with by the sender (FIG. 5.4 and 5.6).

17. The method of claim 11 wherein the FROM field is editable and the TO field is not shown, and it is taken from an encrypted variable part of the URL of the form, so this form can be used on Internet pages by the any sender trying to reach the recipient without the recipient disclosing his/her email address, and the sender can not tamper With the TO field (FIG. 5.6).

18. The method of claim 11, wherein the mentioned Internet contact-me form is disabled for a period of time for a specific email and/or specific IP address when the information has been submitted (FIG. 5.8).

19. The method of claim 9 wherein if the web server, e-mail server, email client and/or the anti-spam system method and apparatus can be in different networks, computers or servers in remote locations, and they can communicate among themselves using any tools and protocols to send the SUBJECT, MESSAGE, FROM, TO and BCC sections of the e-mail message as well as the access code and the decision to accept or reject a message.
